(19) United States
(12) Patent Application Publication
(10) Pub. No.: US 2003/0063805 A1
(43) Pub. Date: Apr. 3, 2003

(54) Method of converting coded video data

(76) Inventors: Cedric Arnaud Lecoutre, Issy Ies Moulineaux (FR); Alexandre Sy, Aulnay Sous Bois (FR)

Correspondence Address: U.S. Philips Corporation, 580 White Plains Road, Tarrytown, NY, 10591, US

(21) Appl. No.: 10/247,926

(22) Filed: Sep. 20, 2002

(30) Foreign Application Priority Data
Sep. 25, 2001 (FR) 0112329

(51) Int. Cl. G06K 9/36; G06K 9/46

(52) U.S. Cl. 382/235; 382/250

(57) ABSTRACT

The present invention relates to a method of converting video data (1) coded according to a block-based coding technique and having a first image format into decoded video data (2) having a second image format. Said method comprises in particular an inverse quantization step (11) able to supply a transformed data error block. It also comprises a filtering/decoding step including the substeps of truncating (21a) a transformed data block, of completing with zeros (21b) the truncated block of transformed data so as to regain a size of the block before truncation, and of inverse discrete transformation (21c) of the block thus supplemented so as to supply a block of decoded filtered data. Finally, it comprises a subsampling step (22) able to supply decoded video data having the second image format. Such a video data conversion method thus allows a large number of format conversions with reduced complexity and good visual quality.

The present invention relates to a method of converting video data coded according to a block-based coding technique and having a first image format into decoded video data having a second image format, said method comprising an inverse quantization step able to supply a transformed data error block.

It finds its application in particular in the decoding of coded images according to the MPEG standard for example, said images having been coded according to a first image format and being decoded according to a second image format.

A known method of converting coded video data having a first image format into decoded video data having a second image format consists of decoding the coded video data with a conventional decoder according to the first image format and then filtering the data thus decoded in order to convert them to the second image format. This filtering operation is performed in the spatial domain. It comprises a subsampling of the video data, generally consisting of a low-pass filtering and a decimation. Such a filtering therefore requires many calculation operations. The coefficients of the filter can be optimized so as to reduce the complexity of use of said filter, but such a solution nevertheless remains costly to implement in terms of calculation resources.

It is possible to take advantage of the information issuing from the decoding by performing a filtering of the data in the frequency domain. The document entitled “Minimal error drift in frequency scalability for motion-compensated DCT coding”, IEEE transactions on circuits and systems for video technology, Vol. 4, N^{o} 4, August 1994, by Robert Mokry and Dimitris Anastassiou, proposes a method as described in the introductory paragraph of the patent application.

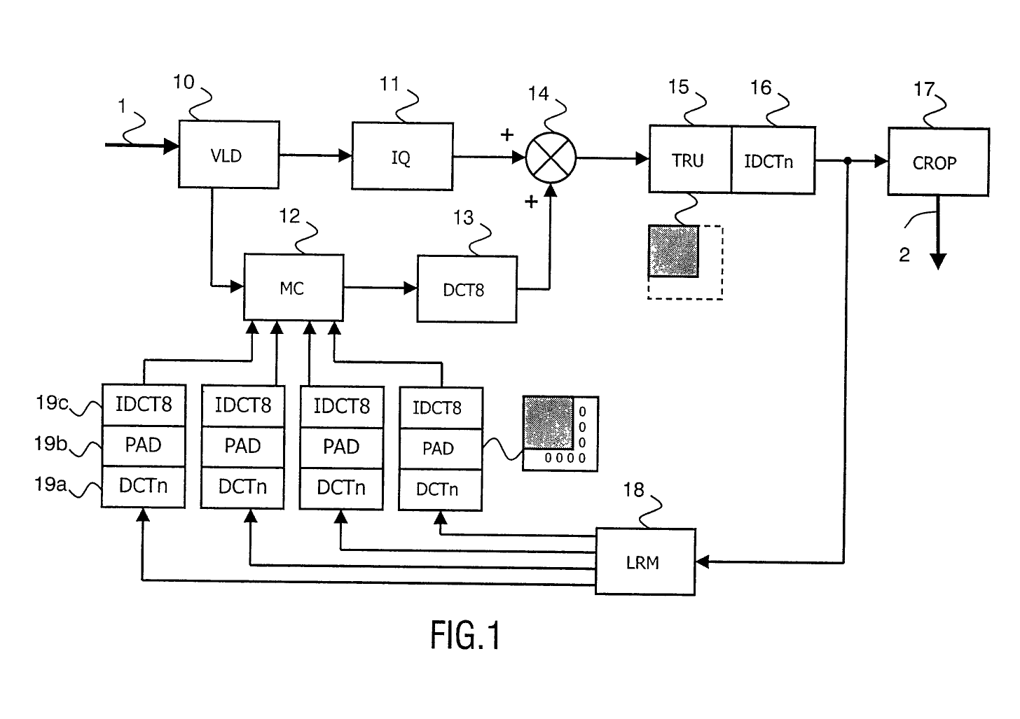

The video data conversion method of the state of the art described in FIG. 1 comprises a variable-length decoding step VLD (10) able to receive the coded video data (1) having a first image format and to supply on the one hand partially decoded video data at an inverse quantization step IQ (11) and on the other hand motion vectors at a motion compensation step MC (12). The motion compensation step supplies a decoded reference data block at a discrete cosine transformation step DCT8 (13) able to process a block of 8×8 decoded data. An addition step (14) adds the blocks of data issuing respectively from the inverse quantization step IQ and from the discrete cosine transformation step DCT8 and transmits the result to a filtering/decoding step. Said filtering/decoding step consists of a substep of truncation TRU (15) of the added transformed data, resulting in a truncated block of 8×n data, n being an integer less than 8 and depending on the ratio between the first and second formats, and a substep of inverse discrete cosine transformation IDCTn (16) of the truncated block of transformed data. The video data blocks thus decoded are then assembled and reframed (17) in order to form a sequence of images having the second image format. Said decoded video data blocks are also stored in a low-resolution memory LRM (18). This memory is able to form four truncated blocks of data which each undergo a processing step consisting of a discrete cosine transformation DCTn (19a), an addition of zeros PAD (19b) to the truncated block of transformed data so as to regain a size of the block for truncation, that is to say here 8×8 transformed data, and an inverse discrete cosine transformation IDCT8 (19c) of the block thus supplemented. The results of this processing step are transmitted to the motion compensation step MC so that this can determine the block of 8×8 decoded reference data within the four blocks of 8×8 processed data.

This solution permits a conversion of video data with format ratios of n/8. Consequently the solution is unsuitable for certain conversions, for example for a format ratio of 2/3, corresponding for example to a conversion of a 3/4 image format (528 columns by 576 lines) into a quarter image format (352 columns by 288 lines), also referred to as the CIF format.

The present invention has for its object to propose a method of converting coded video data having a first image format into decoded video data having a second image format, which allows more format conversions, while remaining of reasonable complexity and preserving suitable visual quality.

To this end, the video data conversion method as described in the introductory paragraph is characterized in that it comprises a subsampling step able to supply decoded video data having the second image format and a filtering/decoding step, between the inverse quantization step and the subsampling step, including the substeps of truncating a block of transformed data, completing with zeros the truncated block of transformed data so as to regain a size of the block before truncation, and inverse discrete transformation of the block thus supplemented so as to supply a block of decoded filtered data.

The conversion method according to the invention firstly allows the reconstruction of an image having a limited frequency content from the blocks of decoded filtered data issuing from the filtering/decoding step, the truncation substep having eliminated the high frequencies which must be filtered before the subsampling in order to avoid spectral aliasing, and the generation of visible defects within said blocks. Secondly it makes it possible to perform a rapid subsampling by simple decimation, keeping for example 2 points out of 3 in the case of a format ratio of 2/3.

Such a video data conversion method thus allows a larger number of format conversions than the state of the art with reduced complexity and good visual quality.

The present invention also relates to a decoding device implementing the video data conversion method.

Finally, it relates to a “computer program” product for implementing the video data conversion method according to the invention.

The invention will be further described with reference to examples of embodiment shown in the drawings to which, however, the invention is not restricted:

FIG. 1 describes the video data compression method according to the state of the art,

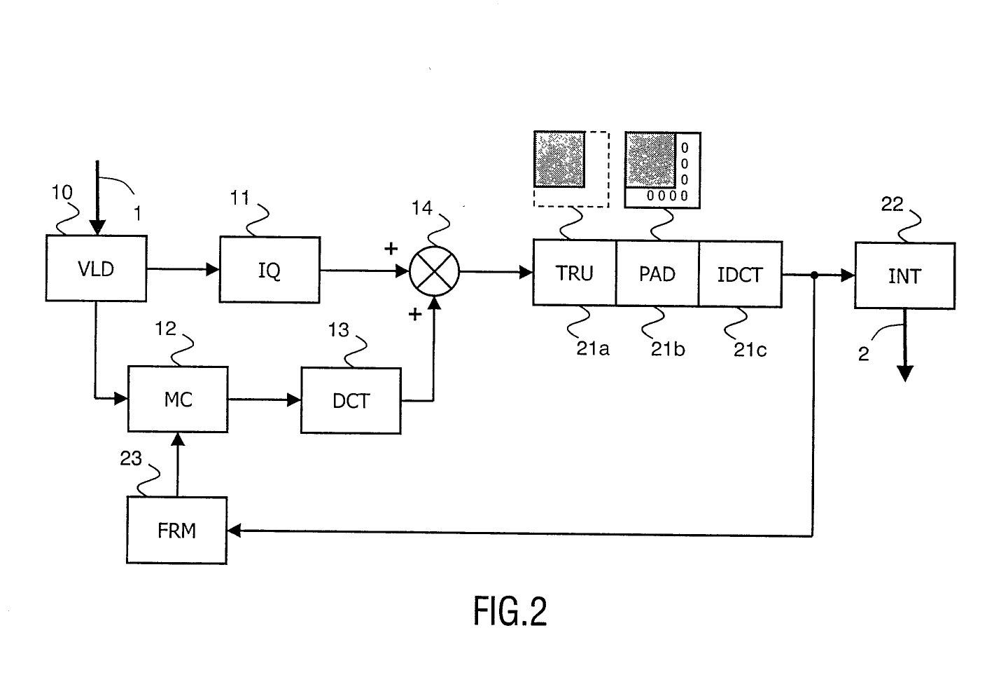

FIG. 2 depicts a first embodiment of the video data conversion method according to the invention,

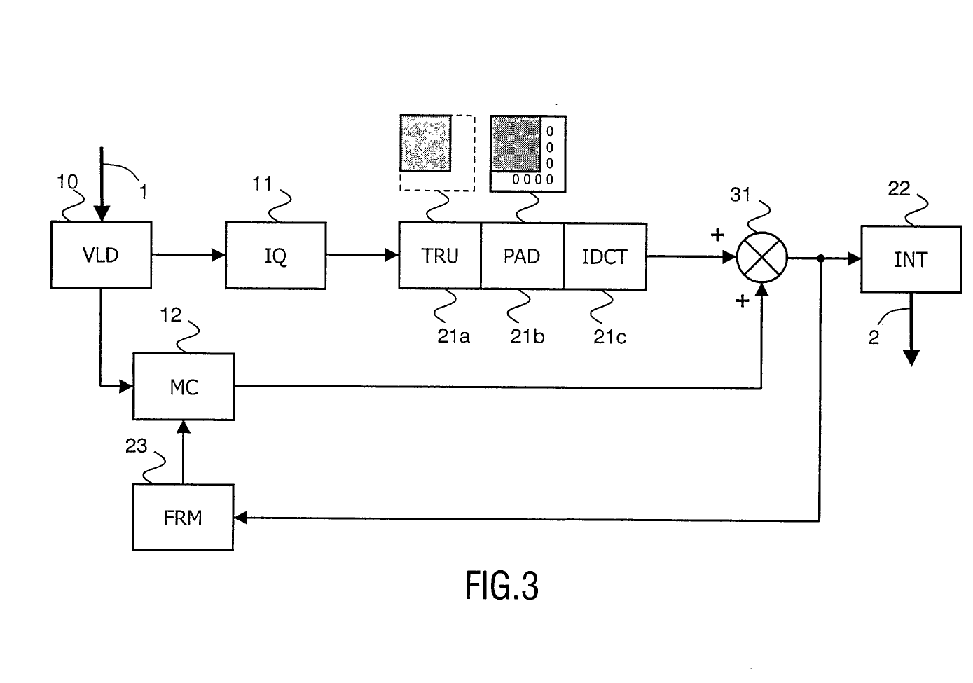

FIG. 3 depicts a second embodiment of the video data conversion method according to the invention, and

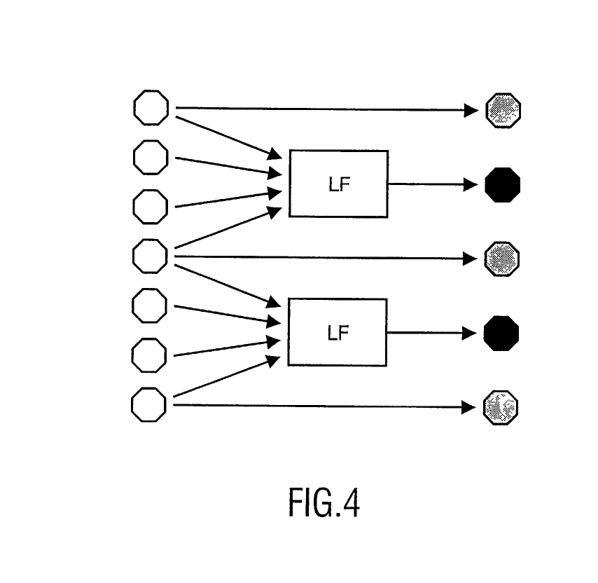

FIG. 4 illustrates the subsampling step of the video data conversion method according to the invention.

The present invention relates to a method of converting video data coded according to a block-based coding technique and having a first image format into decoded video data having a second image format. It applies in particular to the video data coded according to the MPEG standard or according to equivalent standards (H. 261 or H. 263), these standards generally using blocks of 8×8 data. The decoders based on the MPEG standard are able to receive flows of coded video data having different types of input video format such as for example the “full resolution” format (576 lines of 720 pixels), the “3/4” format (576 lines of 528 pixels), the “2/3” format (576 lines of 480 pixels) or the “1/2” format (576 lines of 352 pixels). A video decoder must be able to resize the flow of coded video data into a reduced output format, the “CIF” format (288 lines of 352 pixels) for example. The video data are, in our example, the luminance and chrominance values of pixels contained in a digital image.

According to a first embodiment, depicted in FIG. 2, the video data conversion method according to the invention proposes to effect a resizing of the image in the following manner.

The video data conversion method first of all comprises a variable—length decoding step VLD (10) able to receive coded video data (1) having a first image format and to supply on the one hand partially decoded video data at an inverse quantization step IQ (11) and on the other hand motion vectors at a motion compensation step MC (12). The motion compensation step supplies a block of decoded reference data at a discrete transformation step DCT (13), a discrete cosine transformation in our example or any other equivalent transformation, said transformation being able to transform said block of decoded reference data into a block of transformed reference data.

The video data conversion method also comprises a filtering/decoding step able to process a sum (14) of a transformed data error block supplied by the inverse quantization step IQ and of the block of transformed reference data. The filtering/decoding step includes the substeps of truncation TRU (21a) of the transformed data block issuing from the addition (14), of completion with zeros PAD (21b) the truncated block of transformed data so as to regain a size of the block before truncation, and of inverse discrete transformation IDCT (21c) of the block thus supplemented. The truncation substep consists of extracting, within the block of transformed data, a truncated block of m×n transformed data, m and n being integers less than or equal to the height and width of the input block, this truncated block being situated at top left of the input block and therefore corresponding to the low-frequency transformed data. According to a particularly advantageous variant of this first embodiment, the truncated block corresponds to a fraction of the transformed data block substantially equal to a ratio of the second image format to the first image format, this format ratio being equivalent in some way to a normed cutoff frequency. The substep of completing with zeros the truncated block of m×n transformed data makes it possible to obtain a supplemented block of 8×8 transformed data in the case of the MPEG standard. The supplemented block then undergoes an inverse discrete transformation IDCT, an inverse discrete cosine transformation in our example, or any other equivalent transformation, in order to supply a block of decoded filtered data.

In the case of a conversion of coded video data having a first 3/4 image format into decoded video data having a CIF format, the format ratio is 2/3. According to the particularly advantageous variant of the embodiment, the truncated block of transformed data then contains 8 lines of 5 transformed data, the ratio 5/8=0.625 being as close as possible to the ratio 2/3 while remaining lower than it. Taking more transformed data would give rise to a degradation of the image after the subsampling stage because of the spectral aliasing while taking fewer transformed data would be equivalent to filtering the content of the image excessively.

The video data conversion method comprises a decoded filtered data storage step FRM (23). Unlike the state of the art, the memory FRM contains decoded filtered data which, although having a limited frequency content, have full resolution. The motion compensation step MC can thus directly find a block of reference decoded filtered data in the memory FRM, the decoding thus being optimized thereby. In addition the motion compensation thus effected makes it possible to minimize the drift due to the fact that the decoding uses reconstructed images different from those which the original coder had available to it, so as not to degrade the visual quality of the image after conversion.

Finally, the video data conversion method comprises a subsampling step INT (22) able to receive the block of decoded filtered data and to supply decoded video data having the second format. The subsampling of the data can take place simply by copying certain decoded filtered data, by linear interpolation between two decoded filtered data or by a more complex interpolation.

In the case of a conversion of coded video data according to a format ratio of 2/3, it is for example possible to effect a simple decimation while keeping two decoded filtered data out of three. It is also possible to keep one decoded filtered data item out of three and to generate the other decoded data item by making a linear interpolation on the other two decoded filtered data.

According to a second embodiment corresponding to the preferred embodiment depicted in FIG. 3, the video data conversion method according to the invention proposes to effect a subsampling of the video data in the following fashion.

Said video data conversion method comprises first of all a variable—length decoding step VLD (10) able to receive coded video data (1) having a first image format and to supply, on the one hand, partially decoded video data at an inverse quantization step IQ (11) and, on the other hand, motion vectors at a motion compensation step MC (12) able to supply a block of reference decoded data.

The video data conversion method also comprises a filtering/decoding step able to process a transformed data error block issuing from the inverse quantization step IQ.

The filtering/decoding step includes the substeps of:

truncation TRU (21a) able to extract, within the transformed data error block, a truncated block of m×n transformed data, m and n being integers less than or equal to the height and width of the error block, this truncated block being situated at the top left of said error block;

completing with zeros PAD (21b) the truncated block of m×n transformed data so as to regain a size of the block before truncation, that is to say a supplemented block of 8×8 transformed data in the case of the MPEG standard;

inverse discrete transformation IDCT (21c) of the block thus supplemented in order to supply a block of filtered decoded data.

In the case of a coded video data conversion according to a format ratio of 2/3, the truncated block of transformed data can include 8 lines of 5 transformed data, as in the first embodiment.

According to a particularly advantageous variant of the preferred embodiment, the truncated block corresponds to one half of a block of transformed data. In the case of a conversion of coded video data according to a format ratio of 2/3, the truncated block of transformed data then contains 8 lines of 4 transformed data. Taking only 4 transformed data out of 8 has little effect on the visual quality of the images issuing from the conversion method since the work is now carried out on the error block rather than on the reconstructed block as in the case of FIG. 2. This simplification enables the video data conversion method according to the preferred embodiment to gain in efficiency, in particular with regard to the inverse discrete transformation IDCT, which is thereby greatly simplified.

Finally, the video data conversion method comprises a subsampling step INT (22) able to receive a sum (31) of the block of filtered decoded data and of the block of reference decoded data. The subsampling of the data can be performed simply by copying certain filtered decoded data, by linear interpolation between two filtered decoded data or by a more complex interpolation. According to a particularly advantageous variant of the preferred embodiment, illustrated in FIG. 4, the subsampling is performed by keeping one filtered decoded data item out of three and generating the other decoded data item by making a Lagrange interpolation LF on four decoded filtered data. The Lagrange interpolation uses the following filter [−1/8 5/8 5/8 −1/8]. It has been chosen since it gives better visual results than a linear interpolation, because it is based on a larger number of filtered decoded data, while keeping a low calculation cost.

The video data conversion method of the preferred embodiment does not give an identical result to that of the first embodiment but corresponds to a simplified structure of the latter. It is thereby much more effective while a suitable visual quality of the output image is kept, close to that issuing from the first embodiment of the invention.

There are many ways of implementing the previously described steps by means of software. It is possible to implement these steps by means of a video decoder circuit, said circuit being suitably programmed. A set of instructions contained in a programming memory may cause the circuit to perform the various steps previously described. The set of instructions can also be loaded into the programming memory by reading a data medium such as for example a disk which contains the set of instructions. The reading can also be effected by means of a communication network such as, for example, the Internet. In this case, a service provider will make the set of instructions available to interested parties.

The present invention also relates to a video decoder, the blocks in FIGS. 2 and 3 of the steps of the method corresponding to the circuits of the video decoder. Thus said video decoder transforms the video data coded (1) according to a block-based coding technique and having a first image format into decoded video data (2) having a second image format. For this purpose, it comprises in particular:

inverse quantization means IQ (11) able to supply a transformed data error block,

data subsampling means INT (22), able to supply decoded video data having the second image format, and

a filtering/decoding unit, between the inverse quantization means and the subsampling means, comprising means of truncating TRU (21a) a transformed data block, means of completing with zeros PAD (21b) the truncated transformed data block so as to regain a size of the block before truncation, and means of inverse discrete transformation IDCT (21c) of the block thus supplemented so as to supply a block of decoded filtered data.

Such a video decoder can be used as a first stage of a format transcoder. Said transcoder then comprises, in cascade, the decoder, a format-changing stage and a video coder, with a bus passing information from the decoder to the coder.

No reference sign in parentheses in the present text must be interpreted in limiting fashion. The verb “comprise” and its conjugations does not exclude the presence of elements or steps other than those listed in a sentence. The word “one” preceding an element or step does not exclude the presence of a plurality of these elements or steps.

1. A method of converting video data coded (1) according to a block-based coding technique and having a first image format into decoded video data (2) having a second image format, said method comprising an inverse quantization step (11) able to supply a transformed data error block, characterized in that said method comprises the steps of:
subsampling (22), able to supply decoded video data having the second image format, and
filtering/decoding, between the inverse quantization step and the subsampling steps, including the substeps of truncating (21a) a block of transformed data, completing with zeros (21b) the truncated block of transformed data so as to regain a size of the block before truncation, and inverse discrete transformation (21c) of the block thus supplemented so as to supply a block of decoded filtered data.

2. A video data conversion method as claimed in claim 1, comprising in addition a motion compensation step (12) able to supply a block of decoded reference data, characterized in that the filtering/decoding step is able to process the transformed data error block, and in that the subsampling step (22) is able to receive a sum (31) of the decoded filtered data block and the decoded reference data block.

3. A video data conversion method as claimed in claim 2, characterized in that the truncation substep (21a) is able to truncate one half of the transformed data error block.

4. A video data conversion method as claimed in claim 1, also comprising a motion compensation step (12) able to supply a block of decoded reference data, and a discrete transformation step (13) able to transform the block of decoded reference data into a block of transformed reference data, characterized in that the filtering/decoding step is able to process a sum (14) of the transformed data error block and the transformed reference data block and in that the subsampling step (22) is able to receive the decoded filtered data block.

5. A video data conversion method as claimed in claim 4, characterized in that the truncation substep (21a) is able to truncate a fraction of the transformed data block issuing from the sum (14), substantially equal to a ratio of the second image format to the first image format.

6. A video data conversion method as claimed in claim 1, characterized in that the subsampling step (22) uses a Lagrange interpolation.

7. A device for decoding video data coded (1) according to a block-based coding technique and having a first image format into decoded video data (22) having a second image format, said device comprising inverse quantization means (11) able to supply a transformed data error block, characterized in that it also comprises:
subsampling means (22), able to supply decoded video data having the second image format, and
a filtering/decoding unit, between the inverse quantization means and the subsampling means, comprising means (21a) of truncating a transformed data block, means of completing with zeros (21b) the truncated transformed data block so as to regain a size of the block before truncation, and means of inverse discrete transformation (21c) of the block thus supplemented so as to supply a block of decoded filtered data.

8. A “computer program” product for video decoding comprising a set of instructions which, when it is loaded into a circuit of said video decoder, causes the latter to implement the video data conversion method as claimed in one of claims 1 to 6.
